(19) United States
(12) Patent Application Publication
(10) Pub. No.: US 2017/0310202 A1
(43) Pub. Date: Oct. 26, 2017

(54) STRUCTURE OF MAGNET MODULE AND YOKE MODULE OF DYNAMO HUB

(71) Applicant: SHUTTER PRECISION CO., LTD., Taichung (TW)

(72) Inventor: PO-CHOU LIN, Taichung (TW)

(73) Assignee: SHUTTER PRECISION CO., LTD.

(21) Appl. No.: 15/374,575

(22) Filed: Dec. 9, 2016

(30) Foreign Application Priority Data
Apr. 26, 2016 (TW) 105112886

(51) Int. Cl. H02K 21/24

(52) U.S. Cl. CPC H02K 21/24

(57) ABSTRACT

A dynamo hub includes a magnet module and a yoke module. The magnet module includes first magnetic pole sections and second magnetic pole sections on opposite sides thereof. The yoke module includes first yoke irons and second yoke irons located on the opposite sides of the magnet module. The first and the second yoke irons are not parallel to the first and the second magnetic pole sections, so that the first and the second magnetic pole sections always cross the first and the second yoke irons in an tilted matter while the magnet module is driven to rotate to reduce the cogging torque when the dynamo hub is running.

### BACKGROUND OF THE INVENTION

### 1. Technical Field

The present invention relates to a dynamo hub, and more particularly to a structure of a magnet module and a yoke module of a dynamo hub.

### 2. Description of Related Art

As shown in FIGS. 1A and 1B, a conventional bicycle dynamo hub provides a generator 10 in an axle of a hub housing. The generator 10 includes a coil unit 11, a magnet module 12 surrounding the coil unit 11, and two yoke modules 13 at opposite sides of the magnet module 12. Each yoke module 13 has a plurality of magnetic pole sections 121, and the yoke modules 13 each has a plurality of claws 131 associated with the magnetic pole sections 121. The yoke modules 13 are fixed to opposite ends of the coil unit 11, and the claws 131 surround the coil unit 11. That could make a small, light, great potential, and great power generator 10.

The magnet module 12 of the conventional dynamo hub has a first side 122 facing of one of the yoke modules 13, and a second side 123 facing the other yoke module 13. The magnetic pole sections 121 on the first side 122 include south pole (S pole) sections and north pole (N pole) sections, which are alternately arranged into an annular shape. The magnetic pole sections 121 on the second side 123 are similar to that on the first side 122, except locations of the S pole sections 121 and the N pole sections 121 are just opposite to that of the magnetic pole sections 121 on the first side 122.

However, when the magnet module 12 is turning, and boundaries 1211 between the magnetic pole sections 121 cross central lines 132 of the claws 131, and the boundaries 1211 are parallel to the corresponding central lines 132, which means that zero degree is an angle between the boundaries 1211 and the corresponding central lines 132. Therefore, the yoke module 13 will generate a great cogging torque when the boundaries 1211 between the magnetic pole sections 121 is crossing central lines 132 of the claws 131, which is harmful to the running of the generator. FIG. 1C shows the change of the cogging torque of the conventional bicycle dynamo hub, in which the maximum cogging torque is about 680 mNewton-meter.

### BRIEF SUMMARY OF THE INVENTION

In view of the above, the primary objective of the present invention is to provide a structure of a magnet module and a yoke module of a dynamo hub, which may generate a low cogging torque when the dynamo hub is running.

In order to achieve the objective of the present invention, a dynamo hub includes a magnet module and a yoke module. The magnet module includes a first side, on which a plurality of first magnetic pole sections are provided, and a second side, on which a plurality of second magnetic pole sections are provided. The first magnetic pole sections includes north pole sections and south pole sections alternately arranged into an annular shape, and the second magnetic pole sections includes north pole sections and south pole sections alternately arranged into an annular shape. An arrangement of the north and the south pole sections of the first magnetic pole sections is opposite to that of the north and the south pole sections of the second magnetic pole sections. The yoke module includes a plurality of first yoke irons and a plurality of second yoke irons. The first yoke irons are located at the first side of the magnet module, each of which has a first claw associated with the first magnetic pole sections while the second yoke irons are located at the second side of the magnet module, each of which has a second claw associated with the second magnetic pole sections. Each of the first yoke irons has a first central line which passes through a first center of a first circle, each of the second yoke irons has a second central line which passes through a second center of a second circle. A plurality of first boundaries are formed between the first magnetic pole sections, and a plurality of second boundaries are formed between the second magnetic pole sections. A first included angle is formed between the first central line and the first boundary while the magnet module is driven to rotate related to the yoke module and the first boundary is crossing the first central line. A second included angle is formed between the second central line and the second boundary while the magnet module is driven to rotate related to the yoke module and the second boundary is crossing the second central line.

In an embodiment, the first included angle is in a range between 5 degrees and 40 degrees, and the second included angle is in a range between 5 degrees and 40 degrees.

In an embodiment, each of the first yoke iron includes a plurality of first yoke iron plates connected together; each of the first yoke iron plates includes a first inner section, a first extending section outwardly projected from an end of the first inner section, a first outer section downwardly projected from an end of the first extending section, and a first claw section outwardly projected from an end of the first outer section; the first claw sections are associated with the first magnetic pole sections of the magnet module.

In an embodiment, lengths of the first claw sections of the first yoke iron plates are the same.

In an embodiment, lengths of the first claw sections of the first yoke iron plates gradually increase from a side of the first yoke iron to an opposite side of the first yoke iron.

In an embodiment, lengths of the first claw sections of the first yoke iron plates gradually reduce from a middle of the first yoke iron to opposite sides of the first yoke iron respectively.

In an embodiment, each of the second yoke iron includes a plurality of second yoke iron plates connected together; each of the second yoke iron plates includes a second inner section, a second extending section outwardly projected from an end of the second inner section, a second outer section downwardly projected from an end of the second extending section, and a second claw section outwardly projected from an end of the second outer section; the second claw sections are associated with the second magnetic pole sections of the magnet module.

In an embodiment, lengths of the second claw sections of the second yoke iron plates are the same.

In an embodiment, lengths of the second claw sections of the second yoke iron plates gradually increase from a side of the second yoke iron to an opposite side of the second yoke iron.

In an embodiment, lengths of the second claw sections of the second yoke iron plates gradually reduce from a middle of the second yoke iron to opposite sides of the second yoke iron respectively.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1A is a perspective view of the generator of the conventional dynamo hub;

FIG. 1B is a sketch diagram of the magnet module and the yoke module of the conventional dynamo hub;

FIG. 1C is a diagram, showing the change of the cogging torque of the conventional dynamo hub when running;

FIG. 2 is an exploded view of a first preferred embodiment of the present invention;

FIG. 3 is an exploded view of the magnet module and the yoke module of the first preferred embodiment of the present invention;

FIG. 4 is a sketch diagram of the magnet module and the yoke module of the first preferred embodiment of the present invention;

FIG. 5A is a sketch diagram of the first preferred embodiment of the present invention, showing the arrangement of the yoke iron of the yoke module and the magnetic pole section of the magnet module;

FIG. 5B is a diagram, showing the change of the cogging torque of the first preferred embodiment of the present invention;

FIG. 6 is a sketch diagram of a second preferred embodiment of the present invention, showing the arrangement of the yoke iron of the yoke module and the magnetic pole section of the magnet module;

FIG. 7 is a sketch diagram of a third preferred embodiment of the present invention, showing the arrangement of the yoke iron of the yoke module and the magnetic pole section of the magnet module; and

FIG. 8 is a sketch diagram of a fourth preferred embodiment of the present invention, showing the arrangement of the yoke iron of the yoke module and the magnetic pole section of the magnet module.

### DETAILED DESCRIPTION OF THE INVENTION

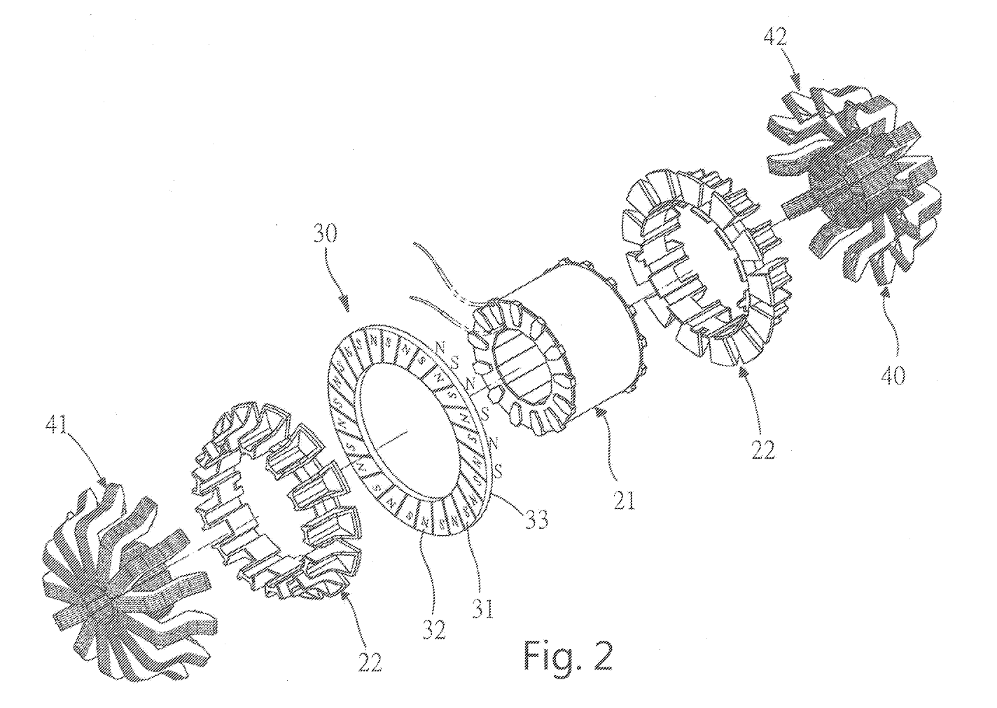

As shown in FIG. 2, a dynamo hub of the first preferred embodiment of the present invention includes a magnet module 30, a yoke module 40, a stator coil module 21, and a holder 22.

The magnet module 30 has a first side 31, on which a plurality of first magnetic pole sections 32 are provided, and a second side 33 opposite to the first side 31, on which a plurality of second magnetic pole sections 34 are provided. The first and the second magnetic pole sections 32 include S pole sections and N pole sections alternately arranged into an annular shape respectively. An arrangement of the S and the N pole sections of the first magnetic pole sections 32 is just opposite to that of the S and the N pole sections of the second magnetic pole sections 34. In other words, backs of the N pole sections of the first magnetic pole sections 32 are the S pole sections of the second magnetic pole sections 34, and backs of the S pole sections of the first magnetic pole sections 32 are the N pole sections of the second magnetic pole sections 34.

The yoke module 40 includes a plurality of first yoke irons 41 and second yoke irons 42. The first yoke irons 41 are located at the first side 31 of the magnet module 30 and each has a first claw 411 associated with the first magnetic pole sections 32 while the second yoke irons 42 are located at the second side 33 of the magnet module 30 and each has a second claw 421 associated with the second magnetic pole sections 34.

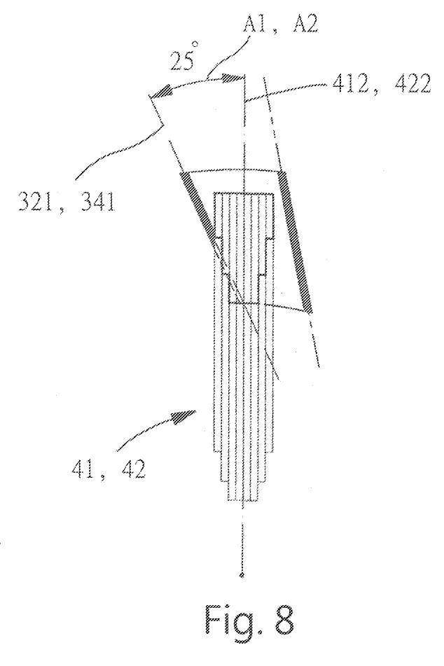

One of the characters of the present invention is that each first yoke iron 41 has a first central line 412 which passes through a first center P1 of a first circle, each second yoke iron 42 has a second central line 422 which passes through a second center P2 of a second circle. First boundaries 321 are defined between the neighboring first magnetic pole sections 32 while second boundaries 341 are defined between the neighboring second magnetic pole sections 34. A first included angle A1 is formed between the first central line 412 of each first yoke iron 41 and the first boundary 321 which crosses the first central line 412 when the magnet module 30 is driven to rotate related to the yoke module 40, and a second included angle A2 is formed between the second central line 422 of each second yoke iron 41 and the second boundary 341 which crosses the second central line 422 when the magnet module 30 is driven to rotate related to the yoke module 40. In an embodiment, the first included angle A1 is 10 degrees, and in another embodiment, the first included angle A1 is in a range between 5 degrees and 40 degrees. In an embodiment, the second included angle A2 is 10 degrees, and in another embodiment, the second included angle A2 is in a range between 5 degrees and 40 degrees. As shown in FIG. 8, both of the first included angle A1 and the second included angle A2 are 25 degrees.

The present invention provides the first central lines 412 of the first yoke irons 41 passing through the first center P1, and the second central lines 422 of the second yoke irons 42 passing through the second center P2. When one of the first boundaries 321 is passing through one of the first central lines 412, the first included angle A1 is formed between the first boundary 321 and the first central line 412. Similarly, when one of the second boundaries 341 is passing through one of the second central lines 422, the second included angle A2 is formed between the second boundary 341 and the second central line 412. In other words, the first boundaries 321 and the second boundaries 341 always cross the first central lines 412 and the second central lines 422 with the included angles (A1 and A2) when the magnet module 30 is turning that could reduce the cogging torque when the dynamo hub is running.

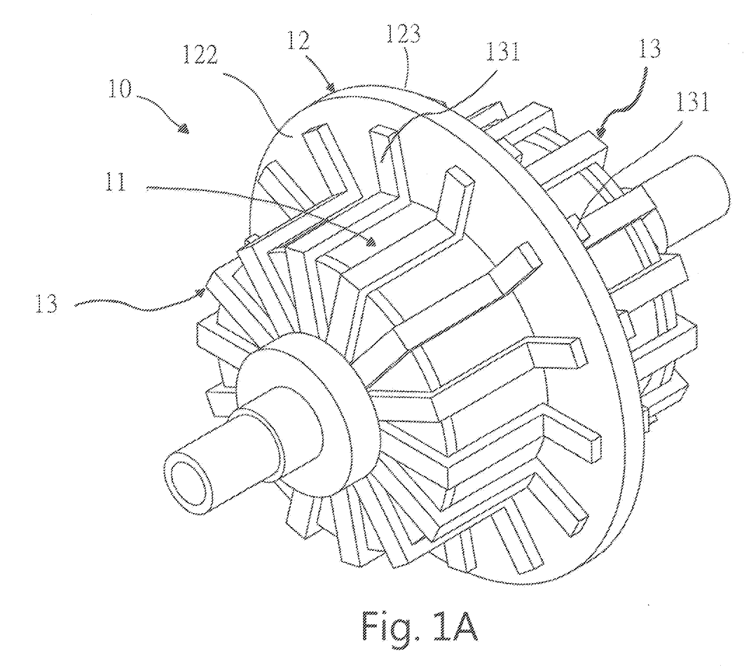

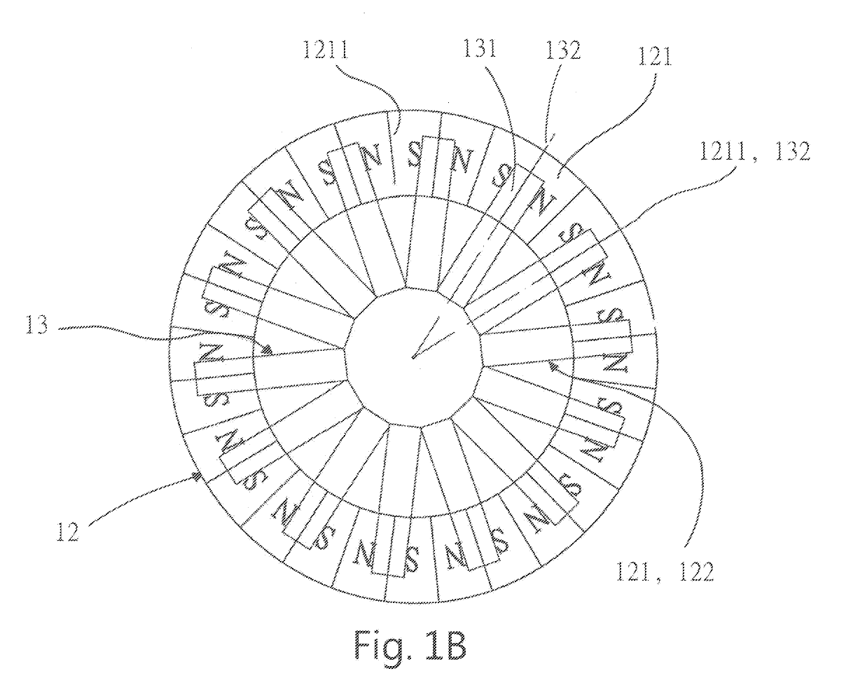

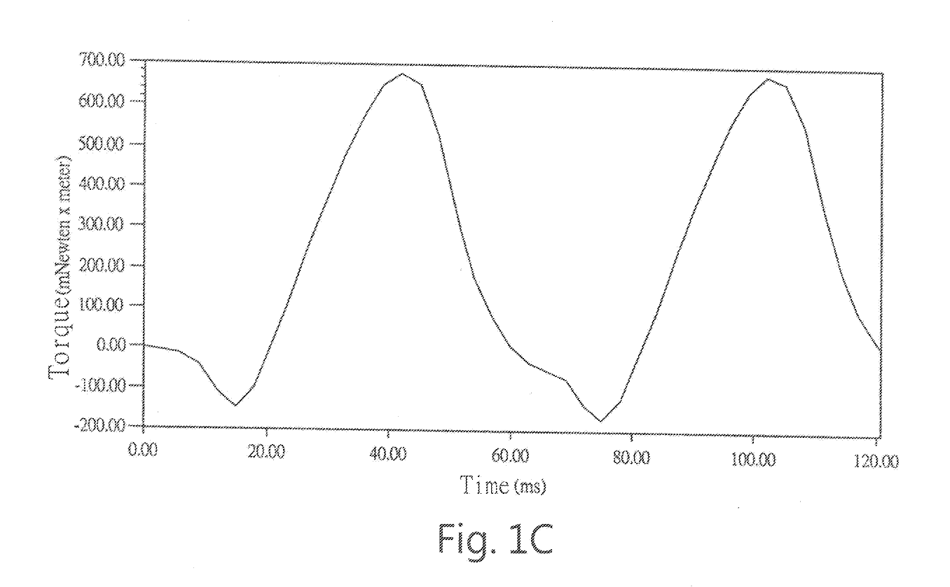

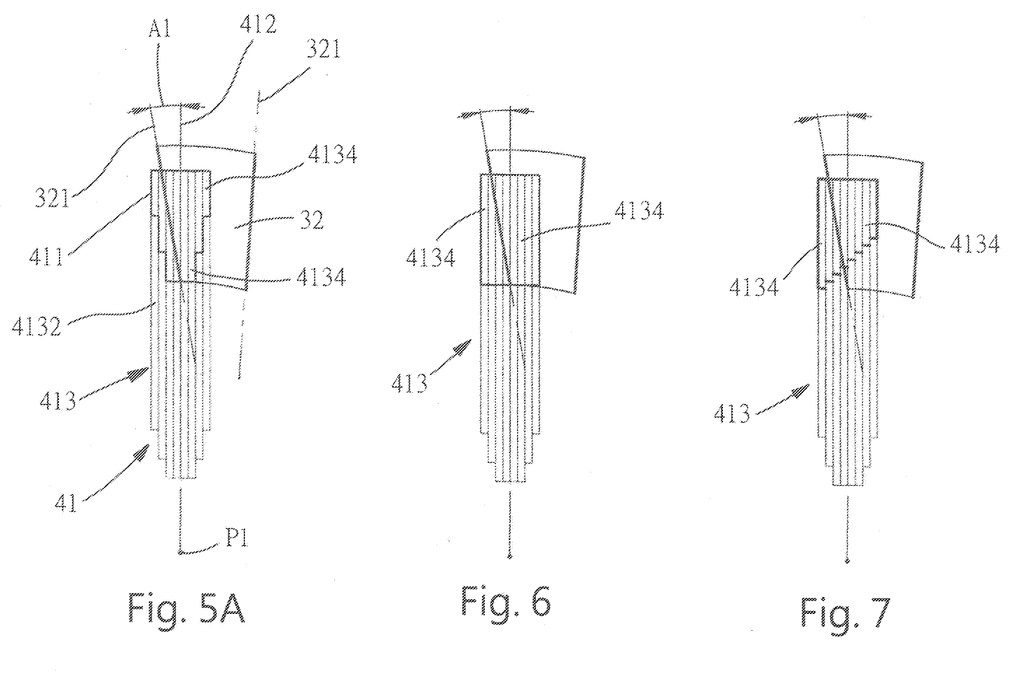

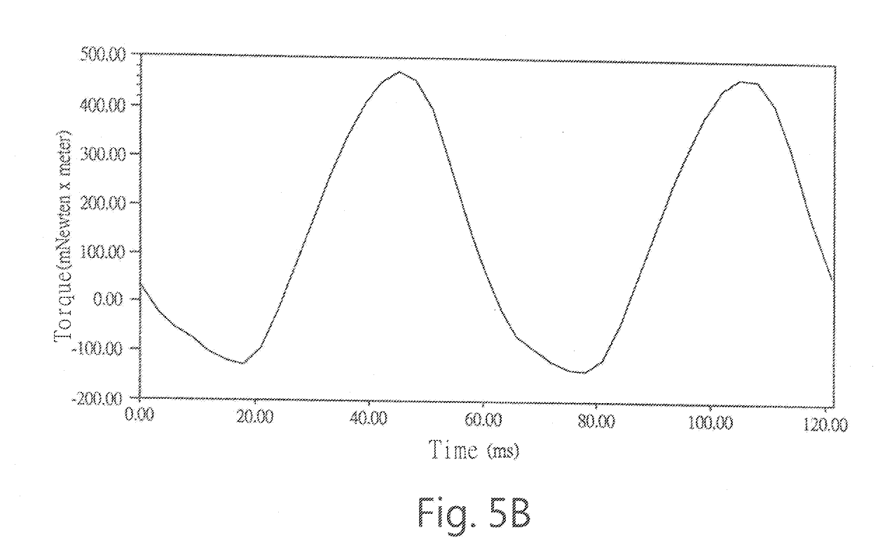

FIG. 5B shows the change of cogging torque of the dynamo hub of FIG. 5A, in which the first boundaries 321 and the second boundaries 341 always cross the first central lines 412 and the second central lines 422 with 10 degrees therebetween. It shows that the maximum cogging torque is about 480 mNewton-meter, which is significantly smaller than that of the conventional dynamo hub as shown in FIG. 1C (680 mNewton-meter). That is a proof of the dynamo hub of the first preferred embodiment has the cogging torque significantly smaller than the conventional dynamo hub.

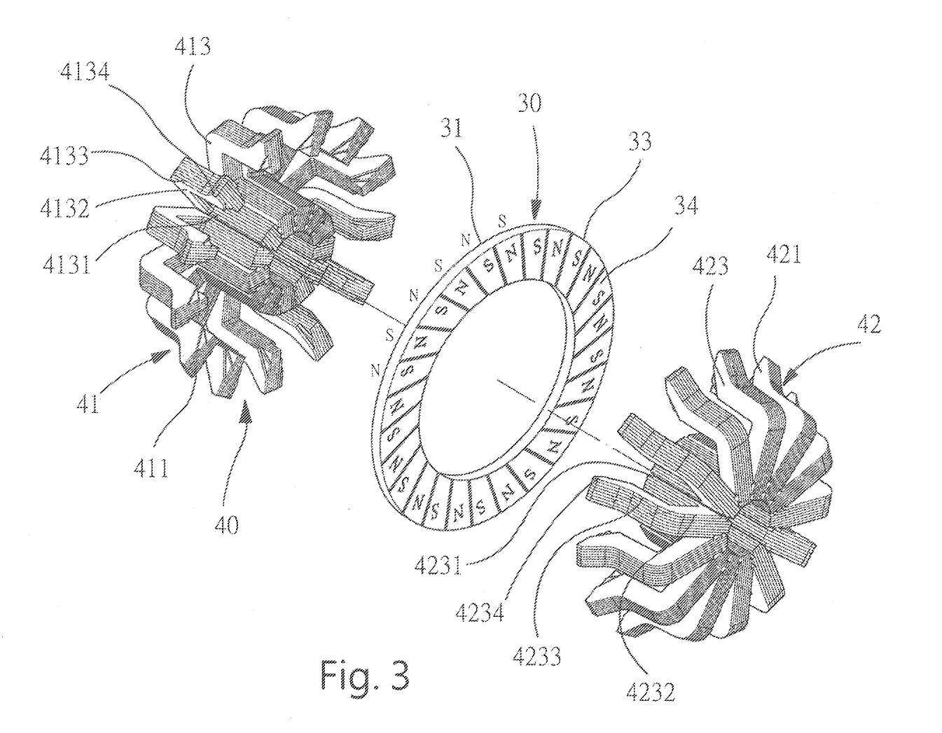

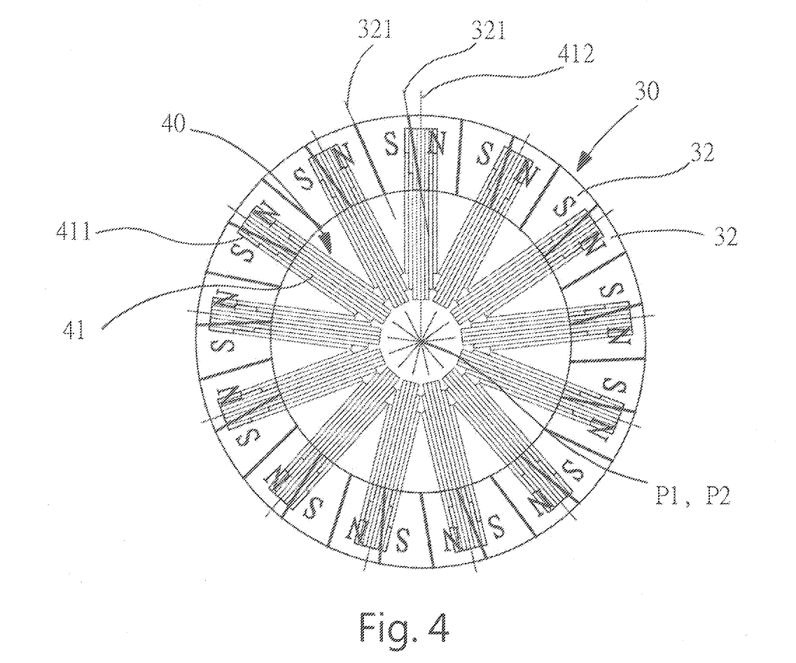

As shown in FIGS. 3 and 5A, each of the first yoke iron 41 includes eight first yoke iron plates 413 connected together. The first yoke iron plates 413 each includes a first inner section 4131, a first extending section 4132 outwardly projected from an end of the first inner section 4131, a first outer section 4133 downwardly projected from an end of the first extending section 4132, and a first claw section 4134 outwardly projected from an end of the first outer section 4133. The first claw sections 4134 are associated with the first magnetic pole sections 32 of the magnet module 30. Lengths of the first claw sections 4134 of the first yoke iron plates 413 of the same first yoke iron 41 gradually increase from opposite sides of the first yoke iron 41 to a middle of the first yoke iron 41. As shown in FIG. 5A, the first claw sections 4134 of four of the first yoke iron plates 413 at the middle of the first yoke iron 41 have the same length, the lengths of the first claw sections 4134 of the second outer first yoke iron plates 413 are shorter than that of the first claw sections 4134 of the first yoke iron plates 413 at the middle, and the lengths of the first claw sections 4134 of the first outer first yoke iron plates 413 are shorter than that of the first claw sections 4134 of the second outer first yoke iron plates 413. In the second preferred embodiment, as shown in FIG. 6, length of all the first claw sections 4134 are the same. In the third preferred embodiment, as shown in FIG. 7, lengths of the first claw sections 4134 of the first yoke iron 41 gradually increase from a side of the first yoke iron 41 to the other side.

In the first preferred embodiment, the second yoke irons 42 are the same as the first yoke irons 41, each of which includes eight second yoke iron plates 423 connected together. The second yoke iron plates 423 each includes a second inner section 4231, a second extending section 4232 outwardly projected from an end of the second inner section 4231, a second outer section 4233 downwardly projected from an end of the second extending section 4232, and a second claw section 4234 outwardly projected from an end of the second outer section 4233. The second claw sections 4234 are associated with the second magnetic pole sections 34 of the magnet module 30. Lengths of the second claw sections 4434 of the second yoke iron plates 423 of the same second yoke iron 42 gradually increase from opposite sides of the second yoke iron 42 to a middle of the second yoke iron 42. The same as the first yoke iron 41 as shown in FIG. 5A, the second claw sections 4434 of four of the second yoke iron plates 423 at the middle have the same length, the lengths of the second claw sections 4234 of the second outer second yoke iron plates 423 are shorter than that of the second claw sections 4234 of the second yoke iron plates 423 at the middle, and the lengths of the second claw sections 4234 of the first outer yoke iron plates 423 are shorter than that of the second claw sections 4134 of the second outer yoke iron plates 423. In an embodiment, the second yoke iron 42 is the same as the first yoke iron 41 as shown in FIG. 6, and in another embodiment, the second yoke iron 42 is the same as the first yoke iron 41 as shown in FIG. 7.

It is noted that each of the first and the second claw sections 4134, 4234 of the first and the second yoke iron plates 413, 423 has an inclined face, and slopes of the first and the second claw sections 4134, 4234 of the first outer 413, 423 are smaller than that of the first and the second claw sections 4134, 4234 of the first and the second yoke iron plates 413, 423. This character is helpful to reduce the cogging torque as well.

It must be pointed out that the embodiments described above are only some preferred embodiments of the present invention. All equivalent structures which employ the concepts disclosed in this specification and the appended claims should fall within the scope of the present invention.

What is claimed is:

1. A dynamo hub, comprising:
a magnet module including a first side, on which a plurality of first magnetic pole sections are provided, and a second side, on which a plurality of second magnetic pole sections are provided, wherein the first magnetic pole sections includes north pole sections and south pole sections alternately arranged into an annular shape, and the second magnetic pole sections includes north pole sections and south pole sections alternately arranged into an annular shape, and further wherein an arrangement of the north and the south pole sections of the first magnetic pole sections is opposite to that of the north and the south pole sections of the second magnetic pole sections; and
a yoke module including a plurality of first yoke irons and a plurality of second yoke irons, wherein the first yoke irons are located at the first side of the magnet module, each of which has a first claw associated with the first magnetic pole sections while the second yoke irons are located at the second side of the magnet module, each of which has a second claw associated with the second magnetic pole sections;
wherein each of the first yoke irons has a first central line which passes through a first center of a first circle, and each of the second yoke irons has a second central line which passes through a second center of a second circle; a plurality of first boundaries are formed between the first magnetic pole sections, and a plurality of second boundaries are formed between the second magnetic pole sections; a first included angle is formed between the first central line and the first boundary while the magnet module is driven to rotate related to the yoke module and the first boundary is crossing the first central line; a second included angle is formed between the second central line and the second boundary while the magnet module is driven to rotate related to the yoke module and the second boundary is crossing the second central line.

2. The dynamo hub of claim 1, wherein the first included angle is in a range between 5 degrees and 40 degrees, and the second included angle is in a range between 5 degrees and 40 degrees.

3. The dynamo hub of claim 1, wherein each of the first yoke irons includes a plurality of first yoke iron plates connected together; each of the first yoke iron plates includes a first inner section, a first extending section outwardly projected from an end of the first inner section, a first outer section downwardly projected from an end of the first extending section, and a first claw section outwardly projected from an end of the first outer section; the first claw sections are associated with the first magnetic pole sections of the magnet module.

4. The dynamo hub of claim 3, wherein lengths of the first claw sections of the first yoke iron plates are the same.

5. The dynamo hub of claim 3, wherein lengths of the first claw sections of the first yoke iron plates gradually increase from a side of the first yoke iron to an opposite side of the first yoke iron.

6. The dynamo hub of claim 3, wherein lengths of the first claw sections of the first yoke iron plates gradually reduce from a middle of the first yoke iron to opposite sides of the first yoke iron respectively.

7. The dynamo hub of claim 1, wherein each of the second yoke irons includes a plurality of second yoke iron plates connected together; each of the second yoke iron plates includes a second inner section, a second extending section outwardly projected from an end of the second inner section, a second outer section downwardly projected from an end of the second extending section, and a second claw section outwardly projected from an end of the second outer section; the second claw sections are associated with the second magnetic pole sections of the magnet module.

8. The dynamo hub of claim 7, wherein lengths of the second claw sections of the second yoke iron plates are the same.

9. The dynamo hub of claim 7, wherein lengths of the second claw sections of the second yoke iron plates gradually increase from a side of the second yoke iron to an opposite side of the second yoke iron.

10. The dynamo hub of claim 7, wherein lengths of the second claw sections of the second yoke iron plates gradually reduce from a middle of the second yoke iron to opposite sides of the second yoke iron respectively.
